(19) United States
(12) Patent Application Publication
(10) Pub. No.: US 2014/0310937 A1
(43) Pub. Date: Oct. 23, 2014

(54) Air Grip Oil Filter Removal Tool

(71) Applicant: Leonard K. Kioko, Ft. Washington, MD (US)

(72) Inventor: Leonard K. Kioko, Ft. Washington, MD (US)

(21) Appl. No.: 14/254,852

(22) Filed: Apr. 16, 2014

Related U.S. Application Data
(60) Provisional application No. 61/813,278, filed on Apr. 18, 2013.

(51) Int. Cl. B25B 27/00; B25B 13/50

(52) U.S. Cl. CPC B25B 27/0042; B25B 13/50
USPC 29/426.5; 81/64

(57) ABSTRACT

The present invention is to an improved a pneumatic oil filter removal tool. The tool has an outer housing formed of a somewhat rigid body surrounding a pressure sleeve. The pressure sleeve has a high friction surface on its interior surface and is shaped to receive a substantially cylindrical oil filter body. An inflation tool is provided to increase the pressure within the pressure sleeve. As pressure increases in the sleeve, an outer rigid wall provided by the rigid body around the sleeve directs the expansion inwardly. The increased pressure thus expands within the housing until it compresses against the filter body to securely receive the filter body. A high friction surface on the interior of the pressure sleeve allows the filter to be rotated as the pressure sleeve and housing are turned. This unique combination forms a pneumatic tool for grasping and turning an oil filter or similar body to be rotated.

### CROSS REFERENCE TO RELATED APPLICATIONS

This application claims the benefit of U.S. Provisional Application Ser. No. 61/813,278, filed 4/18/2013, entitled “Air Grip Oil Filter Removal Tool”, which is incorporated herein by reference.

### BACKGROUND OF THE INVENTION

1. Field of the Invention

The present application relates to a pneumatic tool for removing oil filters and the like.

2. Description of the Prior Art

Modern automobiles have become immensely more complicated. As a result, the engine bays of vehicles have become more crowded with bigger engines, more electronics, as well as greater numbers of sensors and other equipment. One effect of this overcrowding is that oil filters that were previously easily reachable and removable with common removal tools such as an open wrench, are now hidden in tight spaces with limited to room to maneuver tools into contact with the oil filter for removal. Additionally, even if oil filters are accessible, it may be difficult to get a particular tool to latch securely on the oil filter for a number of reasons, including the spanner flats on the body of the filter being poorly constructed, the spanner flats being damaged or stripped, the filter being over tightened in the engine block, or the lack of proper tools for the job.

Car enthusiasts and auto mechanics have developed a number of secondary methods to remove hard to reach oil filters or ones that cannot be remove with a wrench. These methods include the use of friction tools such as a rubber cylindrical cover over the oil filter to provide a better grip on the body of the filter. Another method is to jab a flat head screw driver through the body of the filter to provide a handle for applying torque to the filter. An additional method is to provide a belt or strap that tightens around the filter and is attached to a handle or lever to frictionally engage the filter body and apply twisting motion via the handle to remove the filter

### SUMMARY OF THE INVENTION

The present invention is to an improved a pneumatic oil filter removal tool. The tool has an outer housing formed of a somewhat rigid body surrounding a pressure sleeve for inflating about an object to be rotated. The pressure sleeve has a high friction surface on its interior surface and is shaped to receive a substantially cylindrical object such as an oil filter body. An inflation tool is provided to increase the pressure within the pressure sleeve. As pressure increases in the sleeve, an outer rigid wall provided by the rigid body around the sleeve directs the expansion inwardly. The increased pressure thus expands within the housing until it compresses against the filter body to securely receive the filter body. A high friction surface on the interior of the pressure sleeve increases the frictional engagement of the oil filter in the removal tool allowing the filter to be rotated as the pressure sleeve and housing are turned. This unique combination forms a pneumatic tool for grasping and turning an oil filter or similar body to be rotated.

Accordingly, it is a principal object of a preferred embodiment of the invention to provide a pneumatic tool for rotating a cylindrical object, for example, during removal an oil filter from an engine block or housing.

It is another object of the invention to provide a removal tool having a rigid outer housing, a pneumatic sleeve and a high friction inner surface for rotating an object within the pressure sleeve.

It is a further object of the invention to provide a pneumatic removal tool having an inflation tool for increasing the pressure within the pneumatic sleeve to apply pressure between the removal tool and a body within the pneumatic sleeve.

Still another object of the invention is to provide a pneumatic tool incorporating an outer rigid housing, an inflatable inner portion, an inflation tool for inflating the inner inflatable portion and a non-slip surface for securing a body within the inner portion.

It is an object of the invention to provide improved elements and arrangements thereof in an apparatus for the purposes described which is inexpensive, dependable and fully effective in accomplishing its intended purposes.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### BRIEF DESCRIPTION OF THE DRAWINGS

FIG. 1 is an environmental perspective view of a removal tool according to at least one aspect of the invention.

FIG. 2 is a side elevation view of the device of FIG. 1.

FIG. 3 is a top plan view of the invention according to at least one aspect of the invention.

FIG. 4 is a diagrammatic view of friction surfaces and/or sleeves for the device according to at least one preferred embodiment of the invention.

FIG. 5 is a perspective view of a second embodiment of a removal tool according to a further aspect of the invention.

FIG. 6 is a perspective view of a handle with the pin retracted according to an aspect of the second embodiment of the invention.

FIG. 7 is a cross-sectional, diagrammatic view of the handle with the pin engaged according to the second embodiment of the invention.

FIG. 8 is a cross-sectional, diagrammatic view of the handle with the pin retracted according to the second embodiment of the invention.

FIG. 9 is a partial view of the invention showing a tool-engaging socket for use with the invention.

FIG. 10 is a view of the invention according to another preferred embodiment.

FIG. 11 shows a diagrammatic view of a collapsible embodiment of the invention.

FIG. 12 shows a side elevation view of an additional preferred embodiment.

FIG. 13 shows a side elevation of a further preferred embodiment.

Similar reference characters denote corresponding features consistently throughout the attached drawings.

### DETAILED DESCRIPTION OF THE PREFERRED EMBODIMENT(S)

The present invention is to an improved removal tool for rotating another object or cylindrical body such as an oil filter tool.

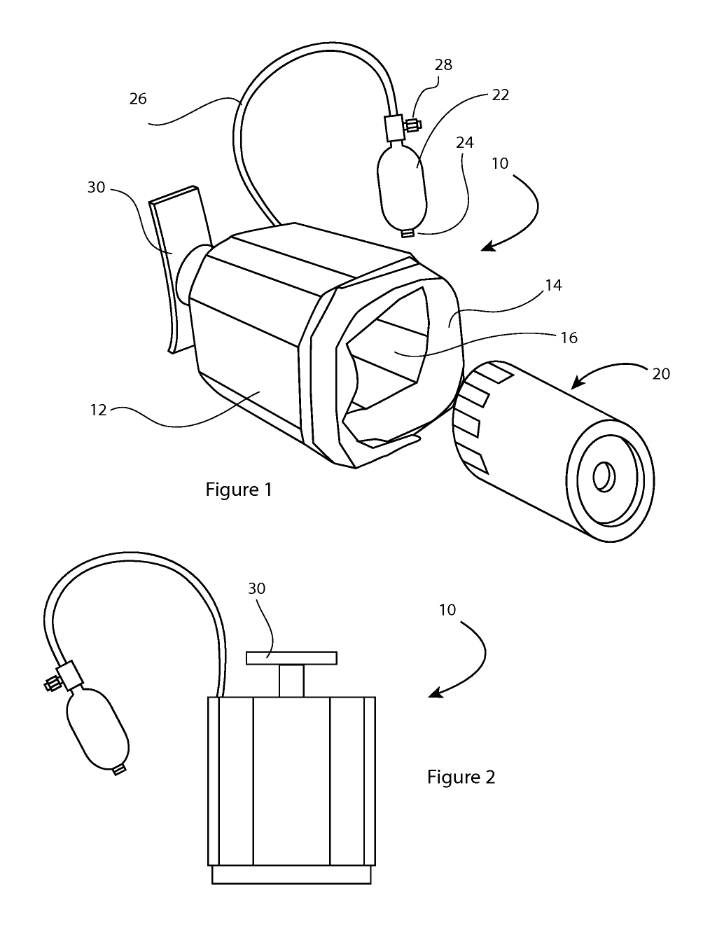

As shown in FIGS. 1-4, a pneumatic, oil filter removal tool 1 is shown. The tool 10 has an outer housing 12 is made from a rigid body such as metal, rigid plastic or the like. The housing is preferably chosen to withstand the heat often found within engine bays where an oil filter would likely be found or to meet other operating parameters wherever the device might be used. The housing may be made from a number of shapes, but is preferably cylindrical or octagonal to provide the maximum area within the housing body. Within the housing is an inflatable sleeve 14 made from a flexible, durable material such as plastic, rubber or the like. The sleeve 14 preferably extends the entire length of the housing and may protrude out one end or may be enclosed entirely within the housing 12. The sleeve may be cylindrical, or may be an elongated “belt” that is rolled or spiraled to fit within the housing. The sleeve is preferably secured within the housing by clips, interference fit, adhesives or other suitable devices or fasteners known to those skilled in the art. The sleeve may also be incorporated permanently within the housing by forming the sleeve unitary with the housing, for example. The pressure sleeve may have one chamber, but is preferably formed as a number of chambers to allow for more uniform pressure around the entirety of the sleeve.

The inner surface of the sleeve includes, is formed as, or is attached to a non-slip surface or sleeve 16. The purpose of the non-slip surface is receive the body 20 to be turned, such as an oil filter, and to maintain a fixed (“locked”) relationship between the removal tool and the oil filter 20 so that rotation of the removal tool results in the same rotation of the oil filter 20. One skilled in the art would appreciate that the tool could be used to rotate other objects, tools or devices other than oil filters. However, for simplicity an oil filter will be used as an example of a body to be removed throughout the application. The non-slip surface 16 can be made from a number of surfaces such as sand paper, grit paper, coarse fiber paper, gnarled surface, coarse plastic, heavy fiber paper, high friction grip cloth or the like. The non-slip surface (see FIG. 4) may have stippled, cross-hatched, striped or random surface patterns to increase grip on the oil tool. The friction surface may be provided as a planar surface or as a sleeve (“cover”) surrounding the entire pressure sleeve or as attachable or incorporated surfaces to one or more portions of the sleeve, especially the inner surface of the pressure sleeve. The surface between the sleeve and the outer housing could also incorporate a high friction surface to maintain the relationship between the sleeve and the outer housing, where necessary.

An inflation tool such as a standard bulb type inflator 22 can be used to inflate the sleeve. The bulb has a first one way valve 24 for allowing air into the bulb, and a second one way valve (not shown) for pressurizing the tube 26 and the pressure cuff 14 and disallowing the air within the tube and cuff from escaping to the environment. One of the valves, or an additional valve, may be used to regulate pressure applied to the sleeve. This regulation valve may be fixed to certain pressure or may be variable. The pressure bulb is connected to the pressure sleeve by the tube 26 and allows for remote actuation of the pressure sleeve without relying on line of sight or direct linear access to the pressure sleeve. The tube may run through the handle or through a portion of the housing to access the sleeve within the housing 12. A release valve 28 may be provided to release air from the system to release the removal tool form the oil filter. The control for releasing air pressure on the sleeve 14 may be on the sleeve, on the housing, or along the inflation control 22 and tubing 26.

A handle 30 can be provided unitary with the housing or connectable to the housing to apply additional torque to the removal tool. The handle is shown as a T handle, but could be in any form capable of providing leverage, such as a wheel or other single lever.

### Operation

In operation, the tool 10 is inserted over the object 20 to be removed such as an oil filter. Once the tool is secured over the oil filter 20, the pressure sleeve 14 is inflated to a suitable pressure to secure the oil filter within the sleeve by pumping bulb 22. The device may include a fixed or variable overpressure relief valve to prevent over-pressurization of the sleeve to protect the system from over pressure. Once the sleeve is pressurized, the oil filter is locked to the removal tool. Non-slip surfaces optionally provided between the sleeve and the removal tool can further ensure that the oil filter will not slip when the tool is rotated. This can be especially important when the oil filter tool is oily or greasy from normal operation of the vehicle in which the oil filter is threadedly installed or from road grime, etc.

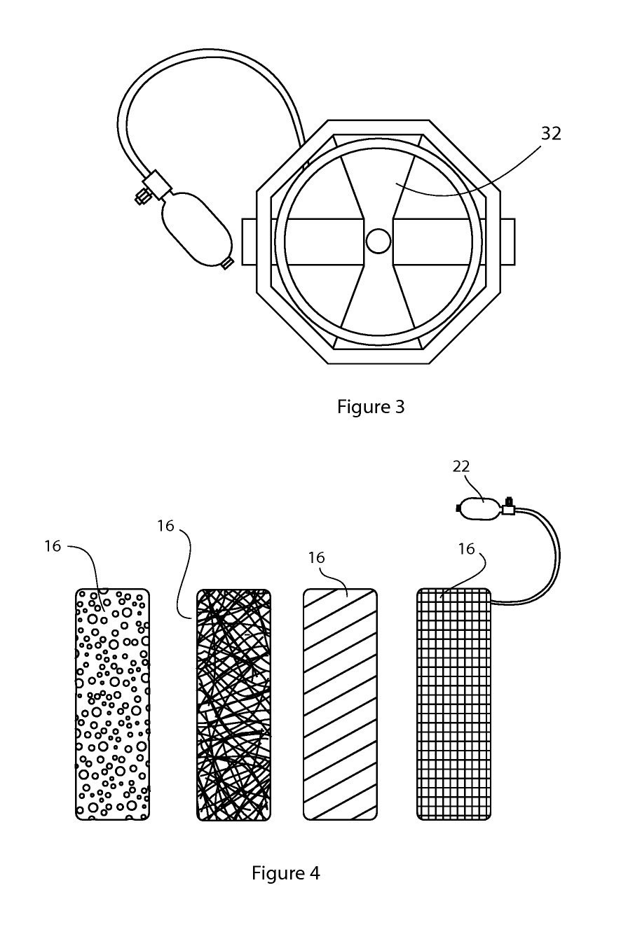

With the removal tool and the oil filter are locked together, torque is then applied to the removal tool to turn the tool. A T-handle or other lever can be used to make turning the tool easier. As the tool turns, the pressure and friction surfaces transfer the torque to the oil filter. The handle could be removable from the tool, but is preferably permanently connected. The handle could be attached to the housing by appropriate crossbars 32 (FIG. 3) or the end of the housing could include an entire wall or sections of a wall.

Because the oil filter may be found in tight compartment within the engine bay or be located deep within the engine bay, having the handle and the tool as a single, connected unit to the oil filter allows for the ready application of torque where tools and other devices may not allow the user to, for example, provide ample gripping of the naked hand. The use of a T-handle or other level allows the user to provide more torque than would be available by grabbing the oil filter and turning it directly without a tool. Additionally, the flexible, extended hose allows the application of pressure to be applied from a location remote from the secluded location of the oil filter.

If the oil filter slips for some reason, additional pressure can be provided to the pressure cuff to increase the friction on the outer surface of the oil filter to further lock the removal tool and the oil filter together. If an over-pressure valve or pressure limit valve is provided, the valve may need to be adjusted to allow additional pressure to accumulate with the pressure sleeve 14. Once the additional pressure is added, the tool can then be turned to rotate and remove the filter 20.

Once the oil filter is removed from the engine block or housing, the oil filter can be removed from the tool simply by releasing the pressure release valve 28 or otherwise deflating the pressure sleeve. With the pressure released, the removal tool will readily slide off of the oil filter 10.

While the device has been described in a preferred embodiment, the teachings of the present invention could be performed in a number of ways. For example, an electric or powered pump of other varieties could be used to provide pressure to the pressure sleeve. In one further preferred embodiment, the powered pump could have a pressure sensitive control for providing the proper amount of pressure. Additionally a rotation sensor could sense slippage between the oil filter and the tool and increase the pressure to compensate for any slippage. The mini-pump could be mounted to the tool or provided at a remote location. The device could be connected by quick-release connection to a pressure source such as pressure reservoir such as a shop compressor-tank system. A valve or pressure control may be required between the compressor line and the pressure sleeve to selectively or automatically allow inflation of the sleeve from the pressure source.

Additionally the size of the removal tool could be increased or decreased according to the application intended. The removal tool could surround the entire body of, for example, the oil filter or could surround only one area of the circumference to provide a belt-like attachment around the oil filter.

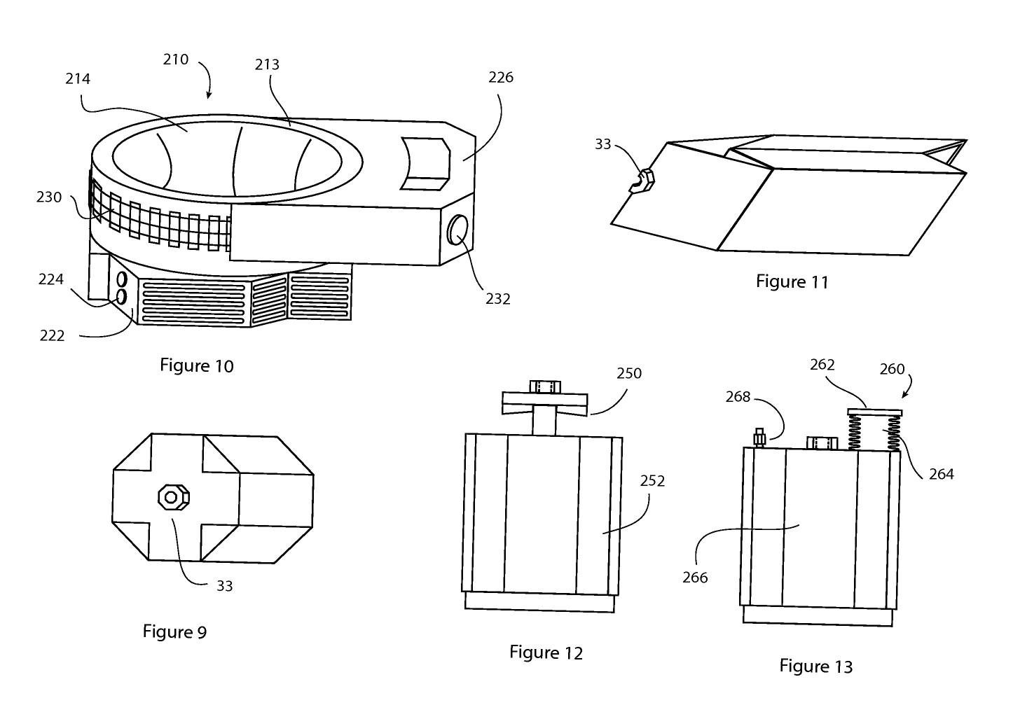

In addition, a nut or a socket (33, FIG. 9) could be provided in addition to or instead of the handle to receive an open wrench, torque wrench or socket wrench for the application of torque/twisting to the tool. The socket could also be provided on top of the handle or the handle could attach to the tool via the socket. The housing could be hinged so that when the tool was not in use the walls of the housing could fold flat around the flexible sleeve for storage. (See FIG. 11). If provided, the nut or socket could also divide in half (33 FIG. 11) to accommodate folding.

### Other Embodiments

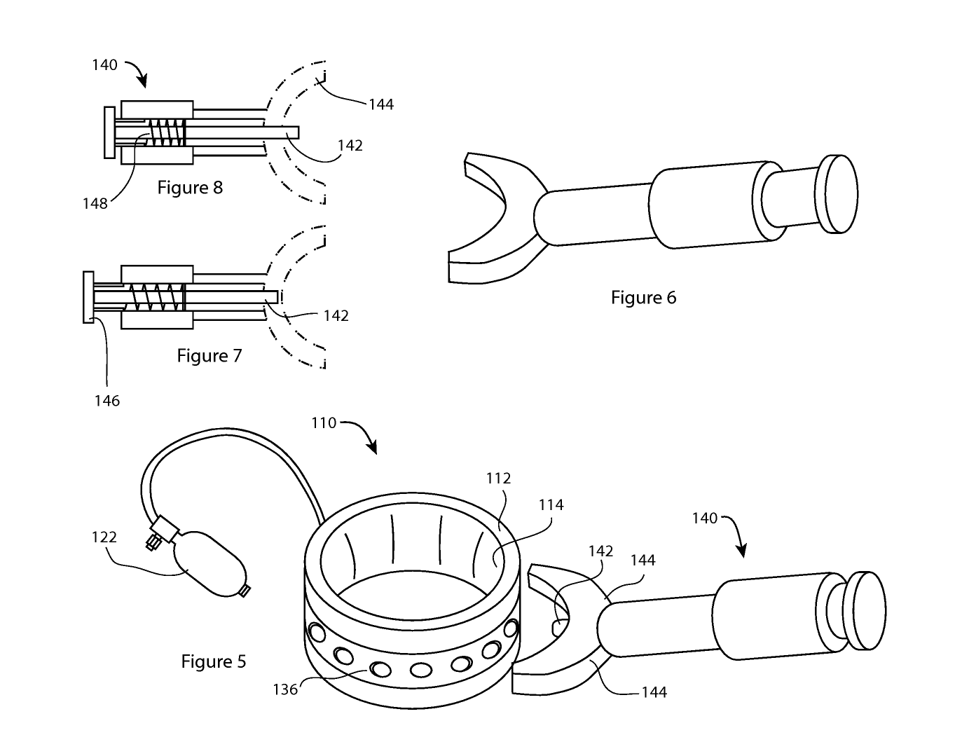

FIG. 5 shows an alternative embodiment of the invention. The removal tool 110 comprises a main cylindrical body 112 including a rigid housing of metal, plastic or other rigid material. The housing preferably incorporates an inflatable, flexible sleeve 114 within the housing 112. The sleeve is situated so as to be able to expand inwardly to trap an oil filter or other device within (not shown). A non-slip or high friction surface may be provided to lock the device within the removal tool 110. An inflation tool may be provided to inflate the sleeve 114 into contact with the device to be rotated. Once the tool is locked over or around the device, a tool may be provided to rotate the removal tool. One such tool 140 may be used in conjunction with the tool. The operating tool/handle 140 may include a pin 142 projecting from an interior surface thereof. The pin is preferably located within two radial arms 144. The pin 142 cooperates with a number of receiving holes 136 on the removal tool. The radial arms 144 are preferably configured to closely receive the radius of the housing 112 so as to bring the pin 142 in close relation to the holes 136 defined within the housing. By inserting the pin into the hole, the operating tool 140 will be locked onto the removal tool 110 to manipulate the removal tool to rotate to the right or to the left. In this way, the removal tool and the device captured within the tool can be rotated to, for example, unthread the device from an engine block or the like.

FIG. 6 shows the tool 140 with the pin optionally retracted/retractable. FIGS. 7-8 show one such method of retracting the pin. The shape of the tool is FIGS. 7-8 is idealized to more clearly show the pin 142 extended beyond arms 144 in FIG. 8 and retracted in FIG. 7. A button 146 on the end of the tool 140 can be depressed against the force of spring 148. The pin 142 connected to the button 146 pushes the end of the pin past the arms 144. The pin may be held down to maintain the pin in the extended position, but preferably a ratchet action (not shown) selectively maintains the button in the depressed position until the pin is pressed again at which time the button and the pin are released, and the spring 148 causes the button and pin to rise to the retracted position.

The pump hose 124 is preferably removable or is long enough to not get tangled while the tool is being rotated. Alternative, a standard valve such as a Shraeder valve or Presta valve or other nipple or the like is provided on the tool such that a conventional chuck on, for example, an airline/air source can be used to inflate the sleeve and then the airline and chuck can be removed to allow the tool to turn unencumbered.

FIG. 10 shows an additional preferred embodiment. FIG. 10 shows an automated removal tool 210. The tool has an outer housing 212 including an outer wall 213. An internal, inflatable sleeve 214 is provided within the rigid outer wall 213 to inflate to thereby contain an object such as an oil filter within the tool 210. The sleeve may be inflated by an electric pump 222. The pump may have controls 224 for controlling the inflation or deflation of the sleeve 214. The pump may also have other sensors or safety equipment such as overpressure sensors to protect the removal tool and/or the object engaged.

The tool may have a handle 226 for manipulating the tool into place, for example, within an engine bay to place over an oil filter. The tool may have automated motor means for rotating the tool. This may include gearing 230 between the handle and the outer wall 213 so that the outer wall 213 and sleeve 214 rotate relative to the handle 226 when the handle is turned manually or under motor action. In the manual mode, the gearing 230 may be a ratchet device that turns the outer wall 213 when the handle is turned in one direction, and the outer wall may stay stationary as the handle is turned in a second direction, depending on whether a button 232 is depressed or not. In a motorized mode, the depression of button 232 may cause a motor to turn the outer housing 213 within or relative to the handle 226. Preferably the outer wall 213 and the sleeve 214 are configured to surround only a portion of an oil filter to grasp the oil filter as a band. Preferably the pump 222 remains stationary while the outer wall 212 and sleeve 214 rotate.

FIGS. 12 and 13 shown alternative embodiments having pumps incorporated into the removal tool. FIG. 12 shows a pump control 250 incorporated into the handle. Manipulating the controls 250 on the handle causes air pockets within the control to pump air into the sleeve within the housing 252. Alternatively, the control 250 operates an electric or powered pump (not shown) to automatically inflate the sleeve. FIG. 13 shows an air pump 260 on top of the housing that operates like a foot pump, where depression of the pump handle 262 downwardly compresses a bellows 264 and causes air to enter the sleeve within the housing 266. In both of these embodiments, valving such as relief valve 268 and directional valving to control the direction of air flow and the amount of pressure may be provided as necessary.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

It is therefore to be understood that the present invention is not limited to the sole embodiment described above, but encompasses any and all embodiments within the scope of the following claims.

I claim:

1. An oil filter removal tool comprising:
a housing having an opening on at least one end;
an inflatable sleeve within the housing for receiving an oil filter; and
a pump in fluid communication with said sleeve for inflating the sleeve to tightly secure the oil filter within the sleeve.

2. The oil filter removal tool of claim 1, further comprising a hexagonal nut centered on one end of the housing for receiving a tool for rotating the housing and oil filter in unison.

3. The oil filter removal tool of claim 1, further comprising a T-handle on one end of the housing for rotating the removal tool and oil filter in unison.

4. The oil filter removal tool of claim 3, wherein said pump is mounted on said T-handle.

5. The oil filter removal tool of claim 1, further comprising a relief valve in fluid communication with said pump for releasing the pressure within the sleeve to release the oil filter from the sleeve.

6. The oil filter removal tool of claim 1, further comprising a high friction surface on said sleeve to increase the friction between the oil filter and said sleeve;
wherein said high friction surface is chosen from one of the group of sand paper, grit paper, coarse fiber paper, gnarled surface, coarse plastic, heavy fiber paper, and high friction grip cloth.

7. The oil filter removal tool of claim 1, wherein said housing is collapsible and can fold flat when the sleeve is removed from the housing.

8. The oil filter removal tool of claim 1, wherein said housing sidewalls are hinged about the center of the sidewalls to allow the housing to collapse.

9. The oil filter removal tool of claim 1, wherein said pump is motorized.

10. The oil filter removal tool of claim 1, wherein said pump is mounted on said T-handle.

11. A method of removing an oil filter from an engine block, comprising:
providing a oil filter removal tool having a housing with an opening on at least one end of the housing;
providing an inflatable sleeve within the housing sized to receive the oil filter installed on an engine block;
providing a pump in fluid communication with said sleeve for inflating the sleeve;
inserting said sleeve and housing over the oil filter;
inflating the sleeve to frictionally bind the oil filter to the sleeve;
rotating the housing which thereby rotates the sleeve and the oil filter until the oil filter is free from the engine block.

12. The method of removing an oil filter from an engine block of claim 11, further comprising:
releasing the pressure from the sleeve after oil filter has been rotated free from the engine block;
removing the oil filter from the sleeve and from the housing.

13. The method of removing an oil filter from an engine block of claim 11, further comprising:
providing a relief valve in fluid communication with said pump for releasing the pressure within the sleeve for releasing pressure within the sleeve;
activating the valve to release the pressure from the sleeve after oil filter has been rotated free from the engine block;
removing the oil filter from the sleeve and from the housing.

14. The method of removing an oil filter from an engine block of claim 11, further comprising:
providing a T-handle on said housing for applying rotational torque on the housing.

15. An oil filter removal tool comprising:
a cylindrical housing having an opening on at least one end;
said housing defining a plurality of holes spaced about the cylindrical housing circumference;
an inflatable sleeve within the housing for receiving an oil filter; and
a pump in fluid communication with said sleeve for inflating the sleeve to tightly secure the oil filter within the sleeve; and
a tool having a pin sized to fit within a one of said spaced plurality of holes for rotating the tool by said holes.
